(19) United States
(12) Patent Application Publication
(10) Pub. No.: US 2006/0216383 A1
(43) Pub. Date: Sep. 28, 2006

(54) Method and apparatus for the production of distilled spirits

(76) Inventors: Pawel Jacek Kolodziejak, Podkowa Lesna (PL); Jozef Tadeusz Zukowski, Mazowiecki District (PL)

Correspondence Address: Michael J. Colitz, III;Holland & Knight LLP, Suite 4100, 100 N. Tampa Street, Tampa, FL, 33602, US

(21) Appl. No.: 11/218,350

(22) Filed: Sep. 1, 2005

Related U.S. Application Data
(60) Provisional application No. 60/665,307, filed on Mar. 25, 2005.

(51) Int. Cl. C12H 1/04

(52) U.S. Cl. 426/422

(57) ABSTRACT

The present invention relates to a method for filtering an aged distilled spirit to produce an alcoholic beverage. In one embodiment, the spirit is aged for several years in one or more oak lined casks to impart flavoring. Any color imparted during the aging step is subsequently removed via filtering. Diamond filtration can also be employed to improve taste and texture.

### RELATED APPLICATION DATA

This application claims priority from and is related to commonly owned U.S. Provisional Patent Application Ser. No. 60/665,307 filed on Mar. 25, 2005 and entitled “Method for the Filtration of Aged Distilled Spirits.” The contents of this application are fully incorporated herein.

### BACKGROUND OF THE INVENTION

1. Field of the Invention

This invention relates to a method for the filtration, distillation and/or aging of alcohol to improve the taste, texture and or color of the resulting beverage. More particularly, the present invention relates to a method of filtering an aged distilled sprit to produce a clear alcoholic beverage, and likewise relates to the use of a diamond filter medium to improve taste and texture.

2. Description of the Background Art

The background art contains various methods for the processing and production of distilled spirits. For instance, U.S. Pat. No. 4,792,459 to Krause illustrates a process and apparatus for producing vodka. The process of Krause produces vodka by distilling one aqueous solution of alcohol having a relatively low alcohol content from a poststill. The volume of the solution in the still is maintained by a flow of another aqueous solution of alcohol of relatively high alcohol content. The vapor is condensed to produce vodka.

Another example is disclosed in U.S. Pat. No. 5,370,891 to Fillipova, which illustrates treating a mixture of ethyl alcohol and water for the reduction of impurities. The method includes the step of flowing the mixture through three layers of an activated charcoal adsorber having various surface activities.

U.S. Pat. No. 6,846,503 to Vickers discloses a method for flavoring an ethanolic spirit, such as vodka. The method includes an aging step which is facilitated by one or more aging enhancers. In another step, a precipitate is allowed to form whereby some of the aging enhancers are removed. After the aging step is concluded, the spirit is filtered to remove solids introduced during the aging process.

Another example of an aging process for spirits is illustrated in U.S. Pat. No. 6,506,430 to Zimlich. Zimlich discloses the use of activated carbon to remove excess color from an accelerated oak aged alcoholic product. The invention envisions using the oak aged product to improve the taste of less expensive alcoholic products.

Further still, Russian Patent 2,148,631 to Burachevskii discloses a method of treating an aqueous-alcoholic liquid mixture such that a vodka of 40% strength can be obtained. The method discloses the aging, filtering and bottling of the vodka prepared in accordance with the method.

Although each of the above referenced inventions achieves its individual objective, they all suffer from common problems. For instance, none of the identified methods provide a filtration process for effectively removing impurities from an aged spirit whereby an alcoholic beverage with both an improved taste and appearance is obtained. Additionally, none of the references disclose a method of diamond filtration to improve the taste and texture of the resulting beverage.

### SUMMARY OF THE INVENTION

It is therefore one of the objectives of this invention to provide improved methods of filtering a distilled spirit.

It is also an object of this invention to filter aged distilled spirits to produce clear alcoholic beverages.

Still another object of this invention is to filter distilled spirits via a diamond filtration process to improve texture.

In one embodiment, the present invention is carried out by first distilling an alcohol to yield an alcohol distillate. The distillate is then delivered into a diamond filtering apparatus wherein diamonds are brought into contact with the distillate to improve taste and texture.

The invention can also be carried out by aging a distillate following a first distillation step. A subsequent distillation step is used to remove any coloring added during the aging step.

The foregoing has outlined rather broadly the more pertinent and important features of the present invention in order that the detailed description of the invention that follows may be better understood so that the present contribution to the art can be more fully appreciated. Additional features of the invention will be described hereinafter which form the subject of the claims of the invention. It should be appreciated by those skilled in the art that the conception and the specific embodiment disclosed may be readily utilized as a basis for modifying or designing other structures for carrying out the same purposes of the present invention. It should also be realized by those skilled in the art that such equivalent constructions do not depart from the spirit and scope of the invention as set forth in the appended claims.

### BRIEF DESCRIPTION OF THE DRAWINGS

For a fuller understanding of the nature and objects of the invention, reference should be had to the following detailed description taken in connection with the accompanying drawings in which:

FIG. 1 is a diagram illustrating the initial steps of the method of the present invention.

FIG. 2 is a diagram illustrating the subsequent steps of the method of the present invention.

FIG. 3 is a schematic representation of the fractional distillation apparatus of the present invention.

FIG. 4 is a cross-sectional view of the filtration apparatus of the present invention.

### DETAILED DESCRIPTION OF THE PREFERRED EMBODIMENT

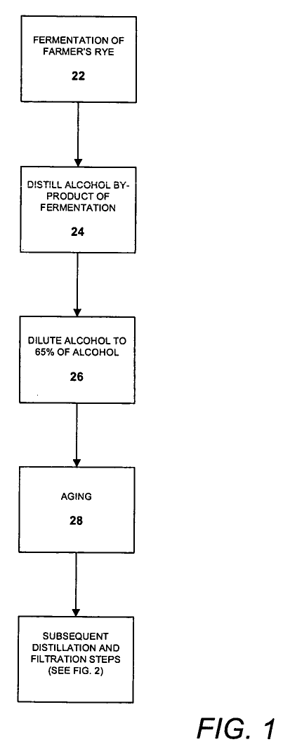

The present invention relates to a method and apparatus for the production of a filtered and distilled spirit. In the preferred embodiment, the invention is used in the production of an aged, clear vodka, although other spirits, such as whiskey, can also be produced in accordance with the present invention. In one particular embodiment, the distilled spirit is filtered with diamonds to improve texture and taste. The details of the present invention are discussed below in conjunction with FIGS. 1-4.

Initial Fermenting and Aging Steps

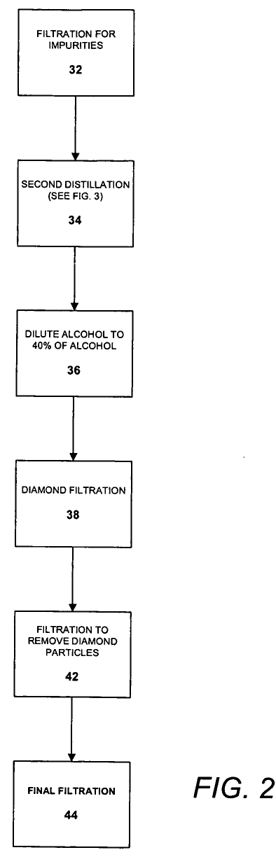

The initial steps of the method include fermentation, distillation, dilution and aging. During fermentation, a volume of starting material is allowed to ferment to yield alcohol. During the distillation step, the purity of the alcohol is increased in a still. The resulting distillate is then diluted with water to achieve an alcohol content suitable for aging. Aging is carried out over a period of several years in oak lined casks. Each of these initial steps is described in greater detail hereinafter in conjunction with the flow chart of FIG. 1. Subsequent method steps are described later in conjunction with FIG. 2.

As noted in step 22, the process begins with a fermentable starting material, which can be a grain. The type of starting material used will depend upon the alcoholic beverage being produced. By way of non-limiting example, the starting material can be a combination of a grain (such as corn, cornmeal, rye or potatoes), and sugar, yeast and/or water. In the preferred embodiment, a starting material consisting of a seasoned farmer's rye of Polish origin is used in the production of vodka. Nonetheless, the present invention can also be used with other starting materials to yield whiskey, rums, cognacs, or bourbons.

Enzymes are then added to the starting material to separate out sugars and convert the starting material into a mash. The mash is subsequently fermented to produce alcohol. Fermentation is a yeast driven reaction whereby the yeast present in the mash breaks down sugars and/or grains to produce alcohol. Thus, the initial fermenting step 22 yields an alcohol that is subsequently processed to yield a final drinkable product, while the remainder of the mash is discarded.

In step 24, alcohol from the mash is distilled to increase the concentration of the alcohol and to remove any impurities left over from the mash. Any of a number of known distillation methods familiar to those skilled in the art can be employed. These distillation processes typically involve heating the alcohol to evaporate the more volatile components and thereby leave behind the less volatile impurities. The vaporized alcohol, or distillate, is then condensed back into a liquid form and collected for further processing. In the present invention, this distillation process is achieved by way of a conventional still (not shown), with the construction and operation of the still being readily apparent to those skilled in the art.

The resulting distillate will have an increased alcohol concentration that is not suitable for either consumption or subsequent aging steps. Namely, the distillate will have an alcohol concentration of approximately 90% by volume, whereas the present inventors have discovered that an alcohol concentration of approximately 65% by volume is best for aging. Accordingly, during step 26 the distillate is diluted with water to produce an alcohol content of approximately 65% by volume. The diluting is preferably carried out with demineralized water because demineralized water does not have any calcium or other minerals that react unfavorably with alcohol. Although alcohol contents other than 65% can be employed with the present method, the inventors have discovered that this is the preferred percentage.

Following the diluting step, in step 28 the distillate is aged in one or more barrels or casks over a period of several years. The barrels used in this step are preferably constructed from oak or have an oak lining. The interior surfaces of the barrels are also cleaned with hard water and steel to smooth the interior surfaces and remove approximately 2 millimeters. The flavor imparted to the distillate by the barrels can also be improved by using barrels that have been previously used to store white wine. These used barrels give the distillate a pleasing wine flavoring. Barrels that were previously used to store other types of beverages can also be used to impart other desirable flavors.

In one embodiment, the aging is carried out in stages using two or more barrels. Staging takes advantage of the fact that smaller barrels impart flavor to the distillate more rapidly whereas larger barrels impart flavor at a slower rate. Moreover, although smaller barrels are preferred for the ability to quickly transfer flavor, larger barrels are preferred for space saving reasons. A combination of smaller and larger barrels is thus used to optimize both flavoring and storage. For example, for a ten year aging process, a larger barrel size of between 10,000 to 30,000 liters is used for a six year aging period and, thereafter, the distillate is transferred to a number of smaller 500 liters barrels for a four year period. In a thirty year aging process, the larger barrel size is used for twenty-five years and the smaller barrel size is used for five years. For a fifty year aging process, the larger barrel size is used for forty years and the smaller barrel size is used for ten years. Finally, if only a two year aging process is desired, all the aging can be carried out in a smaller 500 liter barrel. Those with skill in the distilling and aging arts will appreciate that suitable aging can be achieved over other time periods and with barrels with varying sizes. Likewise, staging can be accomplished with multiple barrels instead of the two barrel process described herein.

Whatever combination of barrels is used, it is important that the oak lining be exposed to the distillate to impart flavor and taste. As part of this aging, thousands of small organic particles are released from the oak into distillate to give the distillate flavor. This results in the distillate taking on a dark, hazy, or cloudy appearance. This coloring is undesirable and can be subsequently removed from the distillate via filtration and/or distillation to produce a clear, aged, distilled alcoholic spirit as desired.

Subsequent Distilling and Filtering Steps

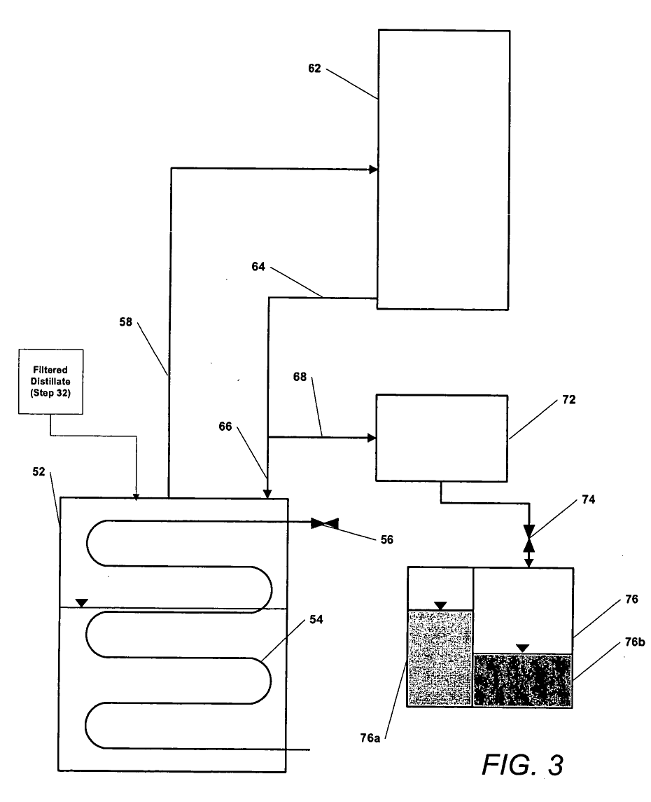

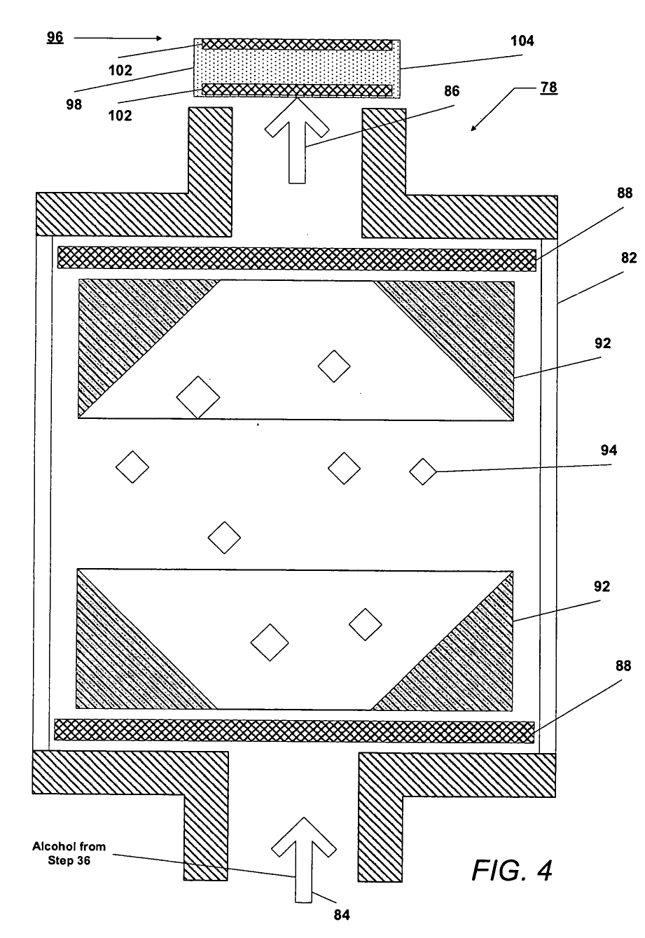

The subsequent distillation and filtration steps are illustrated in FIG. 2. These steps are carried out in the distillation apparatus illustrated in FIG. 3 and the filtration apparatus illustrated in FIG. 4. These additional steps yield an alcoholic beverage ready for consumption and/or bottling.

Filtration step 32 is preferably carried out by a polypropylene filter (not shown) with a mesh diameter of between 0.2 and 5 microns. The purpose of this filtration is to separate from the distillate the particles and/or impurities added from the aging process. Namely, the polypropylene filter is employed in filtering out the small organic particles that have been absorbed from the oak cask. The filtration is preferably fine enough to remove the cloudy or hazy appearance. The specific mesh diameter employed will depend, in part, on what impurities are being filtered and what type of aging casks were used.

As noted at step 34, after the initial filtration, a subsequent distillation step is carried out. However, unlike the distillation of step 24, this subsequent distillation is a fractional distillation carried out with the apparatus schematically illustrated in FIG. 3. The subsequent distillation yields a clear alcohol. FIG. 3 illustrates an evaporator 52 into which the filtered distillate from step 32 is delivered. Once in evaporator 52, the distillate is heated via a steam conduit 54 and nozzle 56. Conduit 54 raises the temperature of the distillate to convert it into a vapor phase. The vapor fraction is then delivered to a partial condenser 62 by way of conduit 58. Fractional distillation is achieved within condenser 62 by allowing the most volatile fraction, the tails fraction, to condense first for delivery back into evaporator 52 via conduits 64 and 66. The remaining distillate, consisting of the head and main fractions, is delivered (via conduit 68) to cooler 72.

Once in cooler 72, the head fraction is condensed first due to its lower boiling point. Once condensed in liquid form the head fraction is delivered into compartment 76a of distillation receiver 76 via conduit 74. The main fraction is condensed only after the head fraction is condensed due to the higher boiling point of the main fraction. Once condensed, the main fraction is delivered via conduit 74 into compartment 76b of distillation receiver 76.

Thus, by way of the fractional distillation, the distillate can be separated into three fractions, with only the intermediate or main fraction being used in the final product. Namely, the tails fraction (condensed within partial condenser 62) constitutes roughly 50% of the distillate and is waste. The head fraction (which is the first to be condensed within cooler 76) constitutes 10% of the distillate. The main fraction (which condenses within cooler 76 after the head fraction) constitutes 40% of the distillate. Only the main fraction is processed further as noted in the subsequent steps.

Following the fractional distillation step 34, at step 36 the distillate is diluted to achieve an alcohol content of 40% by volume. As with dilution step 26, step 36 is carried out by adding demineralized water to the distillate, with demineralized water being preferred due to its lack of reactiveness with alcohol. Although a range of alcohol concentrations can be used in the invention, the inventors have determined that an alcohol content of 40% by volume is preferred for the taste and drinkability of the final product.

After the distillate has been sufficiently diluted, a main filtration step is carried out. The main filtration is achieved in two steps: an initial diamond filtration 38 and a final diamond filtration 42, both of which are carried out in the Filtration apparatus 96 depicted in FIG. 4. Filtration apparatus 78 includes a glass container 82 with an inlet 84 and outlet 86 and intermediate filter media therebetween. In the preferred embodiment, a plurality of loose diamonds 94 comprise the intermediate filter medium. These are preferably whole diamonds of a carat or less and 3 millimeters or less in diameter. In use, these diamonds are kept in suspension within container 82 are used as the initial filtration. Filtration apparatus 78 also includes a pair of wire or mesh screens 88 that are secured adjacent to the inlet and the outlet openings (84 and 86) to prevent the escape of the lose diamonds and to further filter the distillate. With continuing reference to FIG. 4, apparatus 78 further includes nozzles 92 situated at the inlet and the outlet (84 and 86) of housing 82. These nozzles are used in retaining the loose diamonds 94 and in preventing them from gathering in the corners of the apparatus 78.

In use, the alcohol from fractional distillation apparatus (FIG. 3) is delivered into inlet 84 of container 82. The flow of alcohol causes the loose diamonds 94 to become suspended within container 82. The operator of the apparatus can view this process by way of the glass walls of container. The present inventors have discovered that diamonds are an excellent filter and that filtering the distillate with diamonds improves the taste, texture and smoothness of resulting spirit.

In the final diamond filtration stage, diamonds are again used as a filter medium. The preferred final diamond filtration apparatus 96 is illustrated in FIG. 4 and includes a pair of mesh screens 102 that are contained within a housing 98. Any type of mesh screen can be used, although screens with a mesh size of 5 microns or less are preferred. The screens 102 and housing 98 are used to retain a volume of diamond dust or chips 104 through which the distillate passed. The diamonds used in this step are not whole diamonds like those used within container 82, instead diamonds 104 are chips or pieces of diamonds that constitute a dust or powder. The diamonds used in this stage are 5 microns or less in diameter. Final diamond filtration apparatus 96 is primarily used to remove any impurities or diamond particles that may have been added to the distillate within filtration apparatus 78.

As an alternative to the final diamond filtration apparatus 96, a standard cellulose filter can be used with approximately a 1 micron mesh diameter. Again, the object is to remove any diamond particles that may be placed into the distillate by way of the diamond filtration process.

Yet another filtration step 44 can be employed after the final diamond filtration step. Specifically, the alcohol can be filtered through a another standard filter to remove any other contaminates that might be present after the final diamond filtration. This filter is preferably a polypropylene filter with a 1 micron mesh diameter. This final filtration yields a spirit suitable for consumption and/or bottling.

The present disclosure includes that contained in the appended claims, as well as that of the foregoing description. Although this invention has been described in its preferred form with a certain degree of particularity, it is understood that the present disclosure of the preferred form has been made only by way of example and that numerous changes in the details of construction and the combination and arrangement of parts may be resorted to without departing from the spirit and scope of the invention.

Now that the invention has been described,

What is claimed is:

1. A method of producing an aged filtered distilled spirit: comprising the following steps:
fermenting a volume of farmer's rye, whereby alcohol is produced as a by-product;
distilling the alcohol to remove impurities, increase concentration and produce an alcohol distillate;
diluting the alcohol distillate with demineralized water to produce a distillate with an alcohol content of approximately 65% by volume;
providing first and second oak lined barrels, with the first barrel being substantially larger than the second;
aging the alcohol distillate in the first barrel for a first time period;
transferring the alcohol distillate from the first barrel to the second barrel and aging the alcohol distillate for a second time period, wherein the first time period is longer than the second time period;
filtering the aged alcohol distillate through a polypropylene column filter with a mesh diameter of between 5 microns and 0.2 microns to remove any impurities resulting from the aging;
fractionally distilling the aged alcohol distillate whereby an intermediate fraction is separated from initial and final fractions and retained for further processing;
diluting the retained alcohol distillate with demineralized water to produce an alcohol content of 40% by volume;
providing a glass container housing a filter medium of loose diamonds;
delivering the retained alcohol distillate to the glass container whereby the diamonds are placed in suspension and the retained alcohol distillate is filtered by the diamonds to improve taste;
filtering the retained alcohol distillate to remove any impurities resulting from the diamond filtration.

2. A method of processing alcohol to produce a distilled spirit, the method comprising the following steps:
distilling an alcohol to produce an alcohol distillate;
providing a filtering apparatus that includes a container housing a plurality of diamonds, wherein the diamonds are used as a filter medium;
filtering the alcohol distillate with the diamonds of the filtering apparatus to produce a distilled spirit with improved taste and texture.

3. The method as described in claim 2 wherein the plurality of diamonds are loose within the container.

4. The method as described in claim 2 wherein the container includes nozzles to contain the diamonds.

5. The method as described in claim 2 wherein a portion of the filtering apparatus is transparent such that an operator can view the filtration process.

6. A method of processing alcohol to produce a distilled spirit, the method comprising the following steps:
distilling an alcohol to produce an alcohol distillate;
aging the alcohol distillate for at least two years;
fractionally distilling the alcohol distillate to remove any coloring and obtain an intermediate fraction, whereby the intermediate fraction is retained for further processing;
filtering the retained alcohol distillate to remove any impurities added during the aging step.

7. The method as described in claim 6 wherein the aging is carried out in one or more oak lined casks.

8. the method as described in claim 6 wherein the alcohol distillate is filtered via a diamond filter medium following the fractional distillation step.

9. The method as described in claim 6 wherein the method produces a clear, distilled and aged spirit.

10. A method of processing an alcohol distillate comprising:
aging the distillate to impart a flavor;
filtering the distillate a first time to remove any impurities or coloring resulting from the aging step;
filtering the distillate a second time with a filter medium consisting of a plurality of diamonds, wherein the diamonds improve the taste and texture of the alcohol distillate.
